(19) United States
(12) Patent Application Publication
(10) Pub. No.: US 2012/0322327 A1
(43) Pub. Date: Dec. 20, 2012

(54) PRODUCT WITH ABSORBED GEL

(75) Inventor: Enrico Maria Rossi, Vigonza (PD) (IT)

(73) Assignee: GEL INDUSTRY S.R.L., Ostuni (BR) (IT)

(21) Appl. No.: 13/582,743

(22) PCT Filed: Feb. 26, 2011
(86) PCT No.: PCT/IB11/00410

§ 371 Date: Sep. 4, 2012

(30) Foreign Application Priority Data
Mar. 3, 2010 (IT) PD 2010 A 000062

(51) Int. Cl. C08L 25/08; C08L 31/04; B05D 1/18; B32B 5/02; B05D 3/00; B05D 1/26; C08L 25/10; C08L 75/04

(52) U.S. Cl. 442/59; 524/578; 524/575; 524/563; 521/137; 427/398.1; 427/427.4

(57) ABSTRACT

A product with absorbed gel leaving the exposed surface of said product free of stickiness and/or free of the release of oils in any appreciable amounts.

### CROSS-REFERENCE TO RELATED APPLICATIONS

This application claims the benefit of PCT Application PCT/IB2011/000410, filed on Feb. 26, 2011, and incorporated herein by reference.

### FIELD OF THE INVENTION

The field of this invention concerns a method for the direct joining and/or combining of a gel with a substrate of compatible material and relative product obtained. Generally you need to apply a layer of gel, especially a very soft gel, on a suitable support. Indeed it is not possible, both for reasons of cost and for structural reasons, to obtain the entire product exclusively made of gel.

### BACKGROUND ART

Currently, therefore, to apply a layer of soft reticulated, polyurethane or silicone gel, at various thicknesses, on any type of substrate it is necessary to enclose it inside a bag to prevent it dispersing. Nevertheless there is always the risk that this bag could break accidentally, following some abrasion, with the inconvenience of the gel contained in the bag spilling out.

Since, moreover, the shapes of the required products, and in particular of the bags containing said gel, have to satisfy the conditions of use of such products, and above all the bags, they have special spatial forms. In order to be able to confer three-dimensional geometric shapes to said bags, costly and complicated vacuum injection systems are necessary.

In the case where you need to provide certain properties, like the specific ones of a gel, to a support, it is necessary to use a coupling procedure. Indeed, to apply a layer of thermoplastic polymeric gel to a substrate it is necessary to first of all create a panel or a sheet made totally of polymeric gel, then join it to a foamed or fibrous support and then lastly glue said gel with the fibrous support to the substrate.

Nevertheless this procedure has some limitations, i.e. the limits of hardness due to the increasing stickiness of the gels diminishing the hardness.

If you have to use a gel that needs to be confined in a bag there is a serious limitation of the breathability of the surfaces; in fact in the case of the bag there is the impossibility of perforating it after it has been applied.

While in the eventuality of being able to use a gel sheet, to allow the surfaces of the product to breathe it is necessary to provide a certain number of holes, with a dimension and position that is decided a priori; before the mold is made.

It seems clear, therefore, that there is a difficulty in obtaining products, also in small runs or with a limited number of pieces, since it is necessary to vary the surface forms and the positioning of any holes, according to the application, related to the necessary passage through a mold.

In addition to what has been set out earlier, currently the joining of a substrate and a layer of gel takes place with special methods of gluing onto the substrate of a fabric or the like fixed to the accessible surface of a layer of gel when it is still in its molten state.

This is obviously possible only for surfaces of particularly simple gels and as a result the application on corresponding surfaces of the substrate on which it is to be applied.

When the configuration of the substrate has marked contours, hollows, curves, angularity and the like, what has been set out above is no longer feasible.

The purpose of this patent is to overcome the limitations of the well-known technology set out above and those that seem better below in this description.

### SUMMARY OF THE INVENTION

A product with absorbed gel, including a substrate of material that is compatible with the gel, is characterized by the fact that the gel used, which permeates through the substrate of said material, is composed of: a) polymers like SEBS, SBS, SIS, EVA, SEPS, SPBS or their mixture with parts in weight between 5% and 50%; and b) paraffinic or aromatic oil with parts by weight between 95% and 50%; leaving the exposed surface of said product free of stickiness and/or free of the release of oils in any appreciable amounts.

### DETAILED DESCRIPTION OF THE PREFERRED EMBODIMENT

In particular the invention in question concerns a product made of material compatible with a gel directly joined and/or united with a gel, with the merit of being non-sticky to the touch and/or not releasing any residual oil.

The composition of said gel includes a SEBS, SBS, SIS, EVA, SEPS, SPBS polymer or their mixture, with parts by weight between 5% and 50%, and includes a paraffinic or aromatic oil with parts be weight of 95%. So the product can be used directly without any top film to protect the gel, also in the event that the gel is exposed at a thickness beyond the base of the product and not completely absorbed into the substrate of the product.

The above-mentioned gel that allows you to obtain the characteristics mentioned above, with products diffused with gel in the substrate of the product, has the following characteristics, some of which are:
variable hardness;
no residual stickiness;
very low viscosity of the molten material, in all its degrees of hardness, in order to favor its absorption into the substrate;
no release of oils, or in some cases only negligible;
high degree of transparency
better mechanical characteristics than those of gels normally used in similar products;

The formulation of said gel has a hardness that ranges from 5 Sh00 to 10 ShA, in any event an even greater hardness is possible.

This gel is the result of a mixture of at least two SEBS polymers (or other polymers mentioned above) with differing molecular weights and a paraffinic or aromatic oil, and preferably white and of a medical grade (like white Marcol and Primol oils). The SEBS polymers are present in percentages of 5 to 50%. Mixing the polymers with different molecular weights provides surprising characteristics:
the adjustment of the viscosity of the molten liquid in order to favor absorption. For each degree of hardness it is, in fact, possible to find the best composition that provides a molten gel with lower viscosity. As will be explained in the description below, this characteristic is important for obtaining a low viscosity of the molten product that allows the gel to be absorbed in the holes and prevents them being plugged up.
the variation of the mechanical characteristics of the gel to obtain gels that do not need films (i.e. with a barrier layer on the surface in order to overcome the drawbacks of stickiness and the release of residual oil) and with excellent mechanical characteristics. In particular it is possible to eliminate the residual stickiness and prevent abrupt phenomena of wear and tear due to rubbing.
the elimination of the release of oils by the gel or to limit it to practically negligible levels. The benefit of using white medical grade oil is that any small releases are not harmful since the only thing that is released is said white medical grade oil, which is harmless if it comes into contact with skin.
increasing the amount of polymers in the gel without any considerable increases in the hardness and viscosity of the molten product.

In the formulation of said gel it has been seen that in order to prevent releases of oil and to reduce stickiness it is necessary to increase the content of SEBS polymers in the gel. However, the increase in the amount of polymers means substantially increasing the viscosity (in contrast to the low viscosity needed to facilitate absorption into the substrate and to obtain hollow and unblocked ventilation holes in the substrate). This goal has been realized with the adoption of SEBS polymers with different molecular weights. Polymers with a lower molecular weight provide very low viscosity. On the other hand they have slightly inferior mechanical properties to rubbers with a high molecular weight.

Polymers with a low molecular weight also have a lesser capacity for retaining oils.

Therefore, in order to obtain the product of this invention, oils with a suitable viscosity were used; in fact the viscosity of the white oils used has an influence on the release of these very oils by the gel. In particular, the higher their viscosity (measurement method ASTM D445) the more limited is their release by the gel. On the other hand, with oil that has high viscosity there is a sizeable increase in the viscosity of the molten product. The best results in terms of the workability of the molten product and the release of oils by the gel were obtained with white oils with a viscosity between 30 and 100 cSt at a temperature of 40° C. (ASTMD445). The use of high viscosity oils also influences the softening temperature of the gel; in particular oils with a higher viscosity increase them considerably.

Another object of the invention concerns a method for the direct joining and or coupling of a gel with a substrate of compatible material. This method and/or bonding is configured as an absorption and/or diffusion and/or union and/or surface deposition of a film of polymeric gel, with the benefit of a hardness that varies between 5 SH00 and about 10 SHA, to any compatible substrate, with any surface form and with a variable thickness.

This method and/or bonding is a joining of a compatible substrate, like polyurethane foam, viscoelastic polyurethane, latex, sponge, fabrics, and any porous material that can absorb and/or bind with SEBS, SBS, SIS, EVA, SEPS, SPBS polymer based gel or their mixture by means of injection, airless coating, flow coating, spray coating using a solvent, hot coating (in a molten state) immersion or extrusion. This coupling, due to the absorption and/or surface deposition of said gel onto a base, or compatible substrate, considerably modifies the characteristics of the product before and after the treatment according to parameters like: hardness of the absorbed and/or molded gel, depth of penetration, density of the substrate and morphology of the open cells for the foams.

This joining, therefore, is better than a simple gluing of the gel onto the product, since it takes place through absorption with a consequent mechanical seal over the entire contact surface between the two phases, therefore avoiding the need for successive gluing after obtaining the product, as in the case of polymeric gel panels.

An important property of the final product is obtained by controlling the absorption: in fact it is possible to have the gel be fully absorbed into the product and avoid having to cover it with a film or other products to prevent its stickiness and quick degradation due to abrasion. Therefore with the above-mentioned method it is possible and very useful to make small production runs and solutions with multiple structures and forms.

An important benefit consists of the fact that the joined material can be shaped before or after the deposition and/or absorption of the gel in order to increase its breathability.

Another big advantage is that with a final application of a small layer of very hard polymer you completely eliminate the residual stickiness and possible sudden tear action due to the high degree of abrasion, as well as possible release of plasticizers and/or oils. Naturally the above-mentioned products that are obtained can be of any dimension since it is sufficient to modify the dimension of the mixer, fuser or extrusion head to obtain as a result the product obtained.

Advantageously the products obtained with the above-mentioned method and/or union with the coating system have no limits regarding size.

Other numerous advantages obtained with the above-mentioned method and/or union are set out below.

### Perforation of the Products

One important benefit of the above-mentioned product is the possibility of putting holes in the product before or after the coating/absorption with the gel without the danger that, in the event that bags containing gel are used, the gel comes out of the bags, if they are bored after they have been applied, and to put holes in said product in the desired positions through the more common methods of putting holes in fabric, foam or rubber products. Indeed, the application of this soft gel coating and/or absorption of the gel allows you to put holes in the above-mentioned products, before or after the application of the gel, thereby considerably increasing the breathability of the final product, something that is not possible with the insertion of bags containing gel. The making of the holes can be done in various ways on the basis of requirements and can be carried out with all the usual methods for making holes.

There was success, moreover, in keeping the holes of the substrate open by acting on the viscosity of the gel, preventing them from getting blocked, eventually applying a depressurization near the deposition so that the gel penetrates into the holes and is absorbed leaving the hole free. Applying a depressurization also in the post-deposition zone favors the functional capacity of the holes.

Obviously the degree of the depressurization has to be adjustable since:
the height of the substrate where the gel is deposited;
the viscosity of the gel;
the temperature of the substrate;
the treatment speed;
the dimension of the holes:
   all effect the effectiveness of the holes.

The alternative to this, in the event that the holes are for any reason blocked, is the cutting of the piece once the gel has been deposited, something that is possible because the gel is not sticky and does not release residual oils, not only on the surface but also in the material diffused in the substrate of the product.

### The Non-Stickiness of the Outer Layer of Gel

Also considered is the eventual use of a gel with a hardness that is lower than those set out above and that maintains a residual stickiness.

It is possible that after the above-mentioned method the product that is directly obtained has some residual stickiness, due in particular to the very low degree of hardness of the gel employed. This drawback is overcome, completely eliminating the stickiness at the end of the process, with a layer of varnish, or with a compatible polymer with a high degree of hardness (preferably greater than 5 ShA).

The application of a final layer of compatible non-sticky coating (or polymer) allows you to considerably reduce wear and tear due to excessive friction, also the complete absorption of the gel into the substrate eliminates the possibility of the degradation of the gel due to wear.

### The Application of the Layer of Gel on the Substrate Without any Intermediate Gluing

The object of the invention set out in this patent provides for the direct application of the layer of gel onto the suitable substrate without having to make use of intermediate gluing or gluing after the product has been produced.

The regulation of the thickness of the layer of gel based on the number of immersions and/or speed of extraction and/or viscosity of the gel

The thickness of the gel can be continually varied without having to make special molds or equipment. By varying the speed of the extraction, the number of passes of the coating or extrusions, it is possible to put down more layers until the desired thickness of the gel is absorbed and/or deposited.

### Low Costs for Coating Compatible Substrates

The above-mentioned object of the patent provides you with a rapid, quick and inexpensive method for coating compatible substrates. No particular molds or costly production lines are needed.

The surprising effect of the combination of the characteristics of the product obtained and a decrease in degradation

The special soft gel covering allows you to increase the comfort and thermal properties of the substrates on which it is applied. In the case of polyurethanes there is an increase in the lift.

Control over the Depth of the Absorption

With the above-mentioned object of the patent that allows you to regulate the degree of penetration of the gel into the substrate substantially altering the surface properties, i.e. there will be three layers with different characteristics from each other with regards to their mechanical behavior. By varying the thicknesses of each layer it is possible to create a myriad of products all with different characteristics for all requirements.

### Variance of the Surface Forms of the Product Obtained

With the above-mentioned object of the patent it is possible to apply without distinction a layer of gel, with varying degrees of thickness, to a substrate with any type of structure and shape. There is no need for counter-molds or molds since the form of the surface, once the product has been absorbed and/or applied, is that of the substrate.

Variance of the Deposits and Behaviors with the Deposition of Products with Different Characteristics

With the above-mentioned object of the patent it is possible to carry out several depositions and/or absorptions of materials with different properties, both regarding color and mechanics, in order to obtain products with the most diverse properties according to the various requirements, regarding the furniture industry, vehicles, bedding, padding, including medical and orthopedic applications, and with the realization of special aggregates or items that have been covered in or absorbed soft gel with excellent pressure relief, anti-bedsore and comfort properties.

To obtain one or more of these beneficial characteristics, the above-mentioned method and/or coupling, which is the object of the patent, can be carried out in various ways, all falling within a single inventive principle, but realized with the following techniques, set out by way of example only and not meant to be in any way restrictive.

### Immersion Method.

The devices used are a mixer or a fuser, preferably fitted with a high capacity turbine, three-paddle or helix mixer, splined onto a variable speed motor or else on a motor fitted with an inverter.

The gel is melted and the thermostating is maintained, and at this point the mass of the product is ready for coating through immersion.

A chemically compatible or sufficiently porous substrate is immersed into the molten liquid up to the desired level and kept for the time needed for the chemical and/or chemical fixing and the attainment of the required absorbed thickness. Once the fixing time is finished you start to extract the piece from the molten liquid at a constant rate. The piece can be immersed either manually or automatically.

Once the piece has been extracted it is put in a place that is used for cooling.

It is possible to carry out the process more than once in order to reach the desired thickness. It is possible to repeat the process on one or more pieces to obtain different properties for the product obtained.

### Hot Coating Method

The mixer is directly connected to a hot delivery unit that can directly spray the molten product. The delivery unit is normally composed of a pump that can operate at high temperatures, tubes for carrying heated materials and a spray-gun with a hot or cold nozzle.

The film is applied to the substrate using standard coating methods (with usual movement speeds of the spray-gun, delivery pressure and amount of product sprayed).

Once the absorption and/or deposition have been carried out, the piece is put in a place that is used for cooling.

It is possible to carry out the process more than once (over the entire piece or just in parts of it) in order to reach the desired thickness.

It is possible to repeat the process on one or more pieces to obtain different properties for the product obtained.

### Solvent-Based Coating Method.

As far as the attainment of the film using solvent-based spraying is concerned, or else using flow coating technology or airless coating, it is necessary to solubilize the SEBS, SBS, SIS, EVA, SEPS, SPBS material or gel that you intend to deposit to create a coating. Solvents like: xylene, methylethylchetone, toluene, benzene, hexane, cyclohexane and polar solvents are the most suitable.

The material can be solubilized, while continually agitated, until the desired viscosity is reached for the application with percentages in weight between 5% and 30% depending on the composition; The viscosity of the applied product directly influences the thickness that can be attained in a single application and the degree of penetration into the substrate, if this is absorbent with regard to the coating previously obtained.

The application can be carried out using any spray technology, since all viscosities can be reached by increasing or lowering the concentration of the gel or molten polymer.

The film is applied to the substrate using standard coating technologies.

Once the absorption and/or deposition have been carried out the piece is put in a place that is used for the stripping and recuperation of the solvent.

It is possible to carry out the process more than once in order to reach the desired thickness.

It is possible to repeat the process on one or more pieces to obtain different properties for the product obtained.

### Extrusion Method

To carry out the deposition using the extrusion method you can use a standard extruder for polyolefins fitted with a head that is suitable for depositing the film. The material is loaded and then extruded above the substrate that is to be coated. By adjusting the extrusion temperatures and the temperatures of the substrate it is possible to control the viscosity of the gel and therefore the absorption and thickness of the deposition.

A film of gel is applied on the substrate of compatible material, with the requisite speed of movement of the delivery, delivery pressure and amount of product delivered.

Once the absorption and/or deposition have been carried out, the piece is put in a place that is used for cooling.

It is possible to carry out the process more than once (over the entire piece or just in parts of it) in order to reach the desired thickness. It is possible to repeat the process on one or more pieces to obtain different properties for the product obtained.

### Injection Method

To obtain a product that is the result of the union of a compatible substrate and a gel, you insert the previously prepared gel, with properties that are suitable for the injection method, into an injection unit. After bringing the gel to the required injection temperature, and if required having heated the substrate in a closed mold, the injection pressure is adjusted according to the desired thickness of penetration of the gel into the substrate. You then proceed with the injection of said gel into the mold, into which the compatible substrate has previously been put.

By adjusting the injection speed, the injection pressure and the quantity injected, it is possible to obtain the desired thickness of penetration of the gel into the substrate.

It would be beneficial, either before or during said injection phases, that a certain degree of vacuum could be created inside the mold, which would facilitate the penetration and/or diffusion of the gel into the substrate.

Once the injection process is finished and any waiting time is concluded, the product is removed from the mold.

For the above-mentioned methods of application, immersion, hot coating, extrusion, and injection, of the method in the invention, one of the preferred compositions of said gel used is as follows:
SEBS, SBS, SIS, EVA, SEPS, SPBS polymer or their mixture with parts in weight between 5% and 50%.
Paraffinic or aromatic oil with parts by weight between 95% and 50%.

One or more of the following products can be added to the mix, with a relative decrease in the percentage of oil used:
Stabilizers with parts by weight between 0.1% and 0.2%.
Anti-oxidants with parts by weight between 0.1% and 0.2%.
Viscosity modifiers with parts by weight between 0.1% and 0.5%.
Deaereators with parts by weight between 0.1% and 0.3%.
Colorants, as needed.

It is possible to increase productivity and the effectiveness of the penetration of said gel into the compatible substrate using all the application methods set out above, by using a vacuum applied to the product during the coating, immersion, extrusion or injection phase. With special compatible substrate-carrying vacuum masking, or the molten liquid itself in a vacuum, or eventually creating in the mold a certain degree of vacuum, it is possible to obtain greater penetration and/or in a shorter time of said gel into the compatible substrate.

It would be good to use as a gel, in at least one of the above-mentioned methods for carrying out said method that is the object of the invention, a thermosetting gel, mono or bi-component, and have it reticulate once absorbed.

The object of the invention is also the new product, realized according to at least one of the above-mentioned methods, with at least one of the above-mentioned beneficial characteristics, characterized by the fact that it is made up of a substrate of a material compatible with the gel and that it has at least a part of its surface layer that has absorbed or is bonded with the gel.

Where the substrate of this product is at least one of those previously described.

Where the absorbed or diffused gel in at least one surface layer of said substrate is at least one of those previously described.

The drawbacks of the well-known technology and the purposes of this product are those described earlier.

The advantages of this product are at least one of those described earlier.

The methods for creating this product, by way of example only and in no way restrictive, are at least one of the methods set out earlier.

Advantageously, moreover, the final product obtained has a stable composition against stickiness and/or the final layer is a compatible polymer with a high degree of hardness (preferably greater than 5 ShA) and/or with a stable composition.

The final product obtained has physical properties that are an interaction between those of the compatible substrate and those of the gel used without any increase in dimension or thickness with respect to that of the compatible substrate used.

Lastly, this product can have various surface forms and/or a variance in the depositions and properties with deposition of gels with different characteristics, something that has not been possible in the past.

### Detailed Description of an Example of a Preferred and Non-Restrictive Realization

It was said above that one of the assets of the material obtained by the diffusion of the gel in the substrate of the product is its non-stickiness and the fact that oils are not released.

This characteristic allows the product to be die-cut also after impregnation, without the material having any of the above-mentioned problems in the relative perforations.

In the event that the product has had holes put in previously, and it is therefore crucial to keep the holes free and not blocked by the material, a gel is used whose mix has a low viscosity and which spreads easily into the substrate of the material.

By using two products of the Kraton range, Kraton G1654 ES and the Kraton G 1650, the preferred mixtures and preferred gels were obtained. The various Kraton products can be mixed in any proportion to obtain the above-mentioned gels.

In particular, the Kraton G 1654 ES (high molecular weight) used in an amount between 5% and 20% provides excellent mechanical properties. The Kraton G 1650 (low molecular weight) in in percentages between 5% and 30% gives the molten product a low viscosity and allows the rubber content to be increased until it completely eliminates oil leaks or almost completely limits it. Normally the two rubbers are used mixed. In this way it is possible to obtain a gel with optimal mechanical properties, low viscosity to favor absorption, and without oil leaks or just in negligible amounts.

### Detailed Example of a Specific Composition with a Specific Application Method

A preferential composition with excellent mechanical properties, the absence of oil leaks and optimal viscosity is the following: Kraton G 1654 ES 10%; Kraton G 1650 16-18%; white oil (100 cSt at 40° C.) 72-74%.

Using the coating and/or immersion method excellent absorption is obtained of the above-mentioned gel into the substrate. In particular with the immersion method the gel is always kept molten and therefore capable of being absorbed into the substrate (it cannot cool, unlike what would happen pouring the gel over the substrate). In fact, the viscosity of the molten product depends on the temperature and small variations in temperature would convert into huge variations in viscosity with the subsequent impossibility of absorption or of obtaining free holes.

With the coating method it is possible to intervene by varying the rate of the delivery of the product and its movement, so you can obtain a situation that is similar, locally, to absorption. In fact, where the outlet is, where gel comes out in the head, the material is kept molten by the head itself and therefore absorption is possible.

Coating offers the possibility of being able to continually vary the size of the piece:

having a fixed span (width) of deposition dictated by the head; the length of the deposition is not a problem. It is even possible to coat the rolls. To foster absorption and to obtain free holes even if small ones (3 mm in diameter) it is possible to work with the head at a heavy tangent to the piece in order to exploit the sponge effect of the material once it regains it dimensions after being compressed (locally).

Moreover, the coating method allows the gel with a high rubber content (over 30%) to be absorbed better, which otherwise, with absorption, would have been very difficult and slow. Immersion, on the other hand, requires more masks or tanks for carrying out depositions of differing dimensions and lends itself to medium small runs and smallish pieces, 0.5-1 square meter at the most.

In practice the two techniques are complementary:

The absorption method: usually small pieces and high costs for producing a large number of big pieces;

The coating method: even very large pieces (the coating heads used can also be 6 meters long), high rates of production and more convenient absorption for large pieces (more than a square meter) and very long production runs.

What is claimed is:

1. A product with absorbed gel, including a substrate of material that is compatible with the gel, characterized by the fact that the gel used, which permeates through the substrate of said material, is composed of:
a. polymers like SEBS, SBS, SIS, EVA, SEPS, SPBS or their mixture with parts in weight between 5% and 50%;
b. paraffinic or aromatic oil with parts by weight between 95% and 50%;
leaving the exposed surface of said product free of stickiness and/or free of the release of oils in any appreciable amounts.

2. A product with absorbed gel according to claim 1, characterized by the fact that the gel includes at least one of the following compounds:
a. stabilizers with parts by weight between 0.1% and 0.2%;
b. anti-oxidants with parts by weight between 0.1% and 0.2%
c. c) viscosity modifiers with parts by weight between 0.1% and 0.5%;
d. deaereators with parts by weight between 0.1% and 0.3%;
e. colorants, as needed;
with a consequent smaller percentage in weight used of said oil.

3. A product with absorbed gel according to claim 1 or 2, characterized by the fact that at least two polymers are used, one characterized by a high molecular weight with a percentage between 5% and 20%, and the other characterized by a low molecular weight with a percentage between 5% and 30%.

4. A product with absorbed gel according to claim 1 or 2, characterized by the fact that the oil used has a kinematic viscosity between 190 and 320 cP s at a temperature of 20° C. (ASTMD445).

5. A product with absorbed gel according to one or more of the previous claims, characterized by the fact that the gel used is a polymeric gel that has a degree of hardness between 5 SH00 and about 10 SHA.

6. A product with absorbed gel according to one or more of the previous claims, characterized by the fact that the gel used is also outside the compatible support.

7. A product with absorbed gel according to one or more of the previous claims, characterized by the fact that just a part of the substrate absorbed and/or diffused and/or joined to the gel.

8. A product with absorbed gel according to one or more of the previous claims, characterized by the fact that the main components of a preferred composition of the gel are: a) Kraton G 1654 ES 10%; b) Kraton G 1650 16-18%; c) White oil (100 cSt at 40° C.) 72-74%.

9. A product with absorbed gel according to claim 1, characterized by the fact that said substrate that is compatible with the gel is composed of a porous material that can absorb and/or bind with said gel, particularly polyurethane foam, or viscoelastic polyurethane, or latex, or fabrics.

10. A product with absorbed gel according to one or more of the previous claims, characterized by the fact that it is perforable, both before as well as after the gel has been coated onto said compatible substrate and/or the gel has been absorbed into it.

11. A method for making a product according to one or more of the claims from 1 to 10 for joining and/or combining gel with a substrate of compatible material, characterized by the fact that it includes a substrate of material that is compatible with the gel with which you want to bond and/or join, a gel that is compatible with the substrate on which to carry out the bonding and/or joining including the following steps:
a. structurally forming the substrate preferably into the desired final shape;
b. giving the gel the physical and chemical properties appropriate for the bonding and/or joining method;
c. bonding and/or joining said gel to said substrate using absorption and/or diffusion and/or joining and/or surface depostion of the gel onto the surface of the substrate;
d. eventual repetition of the previous step for a number of times in order to obtain the final result desired;
e. eventual replacement of one or more of the previous steps because of the type of gel to be absorbed and/or spread and/or joined and/or laid onto the surface of said substrate;
f. eventual repositioning of the item composed of the substrate of a material compatible with bonding or joining with the gel;
g. eventual cooling.

12. A method for making a product according to one or more of the claims from 1 to 10 for joining and/or combining gel with a substrate of compatible, characterized by the fact that said application of the gel onto the compatible substrate takes place using an immersion method, which has the following steps:
a. the gel is made to melt (molten);
b. the temperature is maintained for at least the duration of the immersion of the substrate in said gel;
c. said substrate is immersed into the molten gel;
d. said substrate is put into the molten gel to the required depth;
e. this is maintained for the time needed for the chemical and/or physical fixing and for the attainment of the desired absorbed thickness;
f. the piece is extracted from the molten gel at a more or less constant speed;
g. eventually the previous steps of immersion, maintaining immersed and extraction are repeated;
h. eventually step g) is carried out in molten gel with different properties or composition to the previous immersion;
i. eventually a certain degree of vacuum is applied, with a substrate-carrying mask or otherwise, at least during one of the initial immersions of the compatible substrate;
j. eventually the substrate is heated at least in the phases preceding the initial immersion(s) of the compatible substrate.
k. the substrate is cooled.

13. A method for making a product according to one or more of the claims from 1 to 10 for bonding and/or combining gel with a substrate of compatible material, characterized by the fact that said application of the gel onto the compatible substrate takes place using a hot coating (molten) method, which has the following steps:
a. a hot delivery unit is used that can directly spray the molten gel, the delivery unit preferably being composed of a pump capable of working at high temperatures, with intake tubes for the material to be delivered suitably warmed, and with a spray-gun with a hot or cold nozzle;
b. a sprayed film of gel is applied onto the substrate of compatible material, with the requisite speed of movement of the spray-gun, the correct delivery pressure and required amount of product being delivered;
c. if needed the previous coating step is completely or partially repeated on part of said substrate, until the required thickness is obtained;
d. if necessary the previous step is carried out with molten gel with different properties or composition to the previous coating;
e. if necessary a certain degree of vacuum is applied, with a substrate-carrying mask or otherwise, at least during one of the initial immersions of the compatible substrate;
f. if necessary the substrate is heated at least in the phases preceding the initial coating(s) of the compatible substrate.
g. the substrate is cooled.

14. A method for making a product according to one or more of the claims from 1 to 10 for bonding and/or combining gel with a substrate of compatible material, characterized by the fact that said application of the gel onto the compatible substrate takes place using an extrusion method, which has the following steps:
a. the product is loaded into an extruder (with screws or pump) equipped with a head suited to laying down the film of gel;
b. the temperature of the extrusion and the temperature of the substrate are suitably regulated;
c. the viscosity is adjusted in line with the expected and desired thickness that can be obtained for each single application and the expected and desired degree of penetration into the substrate;
d. the extruder is capable of applying the previously loaded gel product;
e. a sprayed film of gel is applied onto the substrate of compatible material, with the requisite speed of movement of the spray-gun, required delivery pressure and requisite amount of product;
f. if needed the previous extrusion step is completely or partially repeated on part of said substrate, until the required thickness is obtained;
g. if necessary the previous step is carried out with molten gel with different properties or composition to the previous extrusion;
h. if needed a certain degree of vacuum is applied, with a substrate-carrying mask or otherwise, at least during one of the initial extrusions of the compatible substrate;
i. the substrate is put down.

15. A method for making a product according to one or more of the claims from 1 to 10 for joining and/or combining gel with a substrate of compatible material according to claims 11 to 14, characterized by the fact that the preparation of the gel to be used is carried out using a heated mixer or fuser preferably equipped with a turbine, three-blade or screw type of high capacity agitator, fitted on a variable-speed motor or else on a motor fitted with an inverter.

16. A method for making a product according to one or more of the claims from 1 to 10 for joining and/or combining gel with a substrate of compatible material according to claims 11 to 14, characterized by the fact that the absorbed thickness of the gel in the compatible substrate is proportional to the various application methods and/or the number of passes of the application of the gel onto the substrate and/or the time at least a part of the substrate stays immersed in said gel and/or the speed with which the application and/or bonding method is carried out.

17. A method for making a product according to one or more of the claims from 1 to 10 for joining and/or combining gel with a substrate of compatible material according to claims 11 to 14, characterized by the fact that at least one of the successive passages for depositing one or more layers of gel is carried out with gel with different characteristics.

18. A method for joining and/or combining gel with a substrate of compatible material according to one or more of the previous claims, characterized by the fact that one or more of the methods for applying said gel to the above-mentioned compatible support takes place in a vacuum, preferably applied to the compatible substrate, and if needed making use of special substrate-carrying masks in a vacuum.
